(19) United States
(12) Patent Application Publication
(10) Pub. No.: US 2015/0033277 A1
(43) Pub. Date: Jan. 29, 2015

(54) METHOD OF BUFFER MANAGEMENT FOR SYNCHRONIZATION OF CORRELATED MEDIA PRESENTATIONS

(71) Applicants: Jun Li, Cranbury, NJ (US); Xiaojun Ma, Beijing (CN); Jianfeng Chen, Beijing (CN)

(72) Inventors: Jun Li, Cranbury, NJ (US); Xiaojun Ma, Beijing (CN); Jianfeng Chen, Beijing (CN)

(73) Assignee: THOMSON LICENSING, Issy de Moulineaux (FR)

(21) Appl. No.: 14/379,509

(22) PCT Filed: Mar. 23, 2012
(86) PCT No.: PCT/US2012/030307

§ 371 Date: Aug. 19, 2014

(51) Int. Cl. H04N 21/43; H04N 21/438; H04N 21/41; H04N 21/436; H04N 21/44; H04N 21/462

(52) U.S. Cl. CPC H04N 21/4307; H04N 21/44004; H04N 21/4622; H04N 21/4126; H04N 21/43615; H04N 21/438
USPC 725/116

(57) ABSTRACT

The present invention concerns synchronization of correlated media presentations among two or more media devices. Each device makes a determination as to whether inter-presentation synchronization may be outside of a predetermined tolerance. If so, the device making the determination communicates its buffer and playback status to the other device. Based upon comparison of the buffer and playback status of the local presentation with the buffer and playback status of the presentation at the other device, each device makes a determination as to whether to pause play-back, so as to allow the other device to catch up, advance playback, so as to catch up with the other device, or take no action, allowing the other device to take action to correct the synchronization issue.

### BACKGROUND OF THE INVENTION

The present invention generally relates to synchronization of correlated media presentations among two or more media devices. Each device makes a determination as to whether inter-presentation synchronization may be outside of a predetermined tolerance. If so, the device making the determination communicates its buffer and playback status to the other device. Based upon comparison of the buffer and playback status of the local presentation with the buffer and playback status of the presentation at the other device, each device makes a determination as to whether to pause playback, so as to allow the other device to catch up, advance playback, so as to catch up with the other device, or take no action, allowing the other device to take action to correct the synchronization issue.

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Television viewing has traditionally been a passive single-screen activity. The emergence of the Internet and mobile computing devices, however, has opened possibilities for richer, interactive, multi-screen experiences. For instance, a secondary media presentation comprising content that is coordinated with a primary program displayed on a television may be provided over the Internet to a mobile computing device. The secondary presentation may provide supplemental information about the primary presentation, provide different views of the same event, or provide opportunities for interaction. The multiple presentations, however, will generally require synchronization in order for the user to have the intended experience.

In traditional synchronization methods, a secondary view of a multiple-view presentation follows the timeline of a primary view, such as in the case of lip-sync of an audio-video presentation, and tolerances must be very tight. Since the source of both portions of the presentation is generally the same, however, synchronization can generally be achieved with a static timing adjustment.

In the case of correlated presentations across multiple devices, each presentation is potentially supplied from a different source, and the user may have independent control of playback at each device. Network congestion at one source, or a pause or fast-forward command at one presentation device, for instance, could cause a loss of synchronization.

One method of maintaining synchronization would be for each device to communicate frequently with a centralized server, which could respond with instructions to the devices that would reestablish synchronization. Coordinating playback position via a server produces additional unwanted network traffic, which would be especially problematic when many clients are monitoring the same programs. Network delays may also limit the accuracy of such methods. The invention described herein addresses these and/or other problems.

### SUMMARY OF THE INVENTION

In order to solve the problems described above, we disclose synchronization of correlated media presentations among two or more media devices. Each device makes a determination as to whether inter-presentation synchronization may be outside of a predetermined tolerance. If so, the device making the determination communicates its buffer and playback status to the other device. Based upon comparison of the buffer and playback status of the local presentation with the buffer and playback status of the presentation at the other device, each device makes a determination as to whether to pause playback, so as to allow the other device to catch up, advance playback, so as to catch up with the other device, or take no action, allowing the other device to take action to correct the synchronization issue. This and other aspects of the invention will be described in detail with reference to the accompanying Drawings.

### BRIEF DESCRIPTION OF THE DRAWINGS

The above-mentioned and other features and advantages of this invention, and the manner of attaining them, will become more apparent, and the invention will be better understood, by reference to the following description of embodiments of the invention taken in conjunction with the accompanying drawings, wherein:

FIG. 1 is diagram of a media presentation environment;

FIG. 2A is a timeline view of the status of the playback of two media presentations;

FIG. 2B is a timeline view of the status of the playback of two media presentations, wherein the presentations are out of synchronization;

FIG. 3 is a flow chart of a method of synchronization of media presentations;

FIG. 4 is a flow chart of an alternative method of synchronization of media presentations.

The exemplifications set out herein illustrate preferred embodiments of the invention, and such exemplifications are not to be construed as limiting the scope of the invention in any manner.

### DESCRIPTION OF THE PREFERRED EMBODIMENTS

As described herein, the present invention provides synchronization of correlated media presentations among two or more media devices. Each device makes a determination as to whether inter-presentation synchronization may be outside of a predetermined tolerance. If so, the device making the determination communicates its buffer and playback status to the other device. Based upon comparison of the buffer and playback status of the local presentation with the buffer and playback status of the presentation at the other device, each device makes a determination as to whether to pause playback, so as to allow the other device to catch up, advance playback, so as to catch up with the other device, or take no action, allowing the other device to take action to correct the synchronization issue.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The present invention may be implemented in any combination of television set top boxes, televisions, computing devices, or other electronic devices.

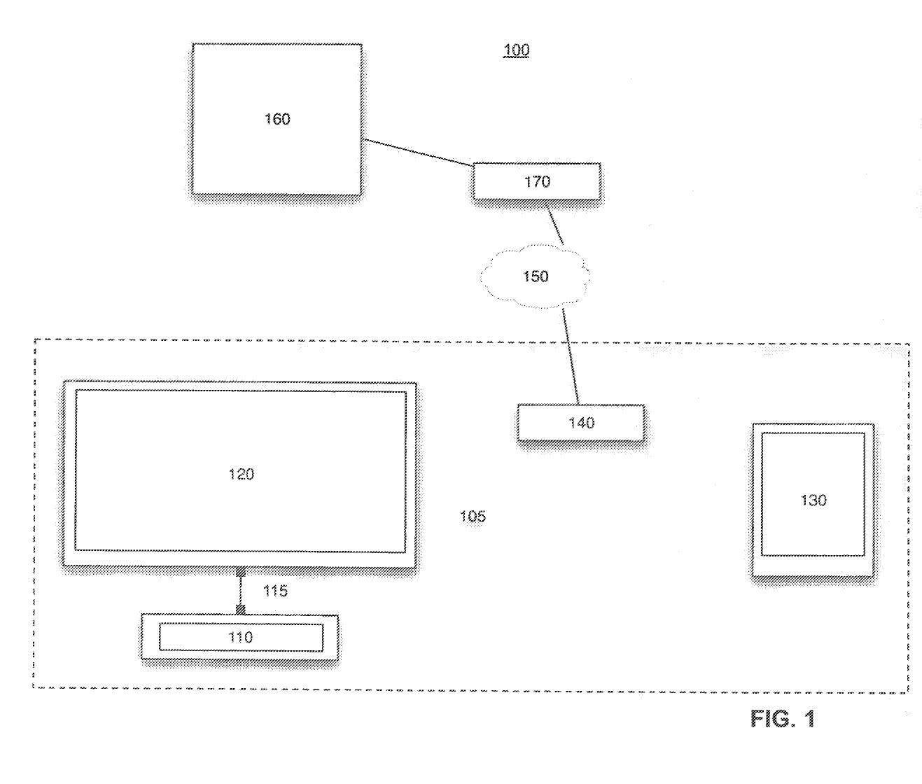

FIG. 1 is a diagram of a media presentation environment 100. Set top box 110 provides audio and video to television 120 via cable 115. Modem 140 provides Internet connectivity and local area networking functionality to the home environment 105. Set top box 110 and mobile computing device 130 access media presentations from server 160 via router 170 and the Internet 150.

The set top box 110 and mobile computing device 130 function as a system to coordinate presentation of the first media presentation at the set top box 110 and a second media presentation at the mobile computing device 130. Synchronization is achieved locally through buffer management at the media presentation devices 110 and 130, rather than via interaction with the server.

In this example, there are two correlated media presentations rendered on two devices connected through a local area network. The number of media presentations and types of media devices may vary within the scope of the invention. In a preferred embodiment, the second media presentation comprises information related to the first media presentation. The first and second media presentations may be provided from the same or different servers and via the same or different network connections. One or both media presentations may comprise video or audio streams, in addition to other data. A video stream may comprise, for example, data encoded in MPEG, Microsoft ASF or WMV, Apple QuickTime or MOV, or RealNetworks RM or RMVB formats. One of the media devices, rather than a server, may serve as the source of one or both presentations.

There are various causes for the loss of synchronization. In some cases, the separate media presentations may come from different servers over different networks, and may face different network congestion conditions that affect delivery of the content. User interaction, such as pausing or fast-forwarding on either device, may also cause the playback positions of the two presentations to diverge.

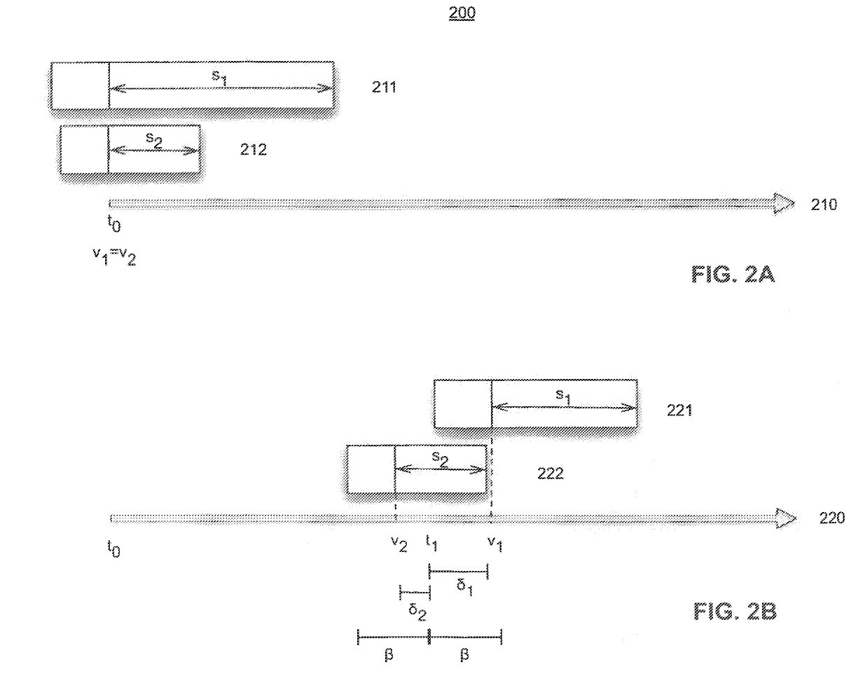

FIG. 2A is a timeline view 210 of the status of the playback of two media presentations at a time t=t₀. In this example, at time t=t₀, the two media presentations are synchronized. The playback position of the first presentation at the first media device, designated v₁, is at the point corresponding to the playback position of the second presentation at the second device, designated v₂. The first media device has a segment 211 of the first media presentation available in a buffer, with the portion s₁ representing content yet to be displayed. The second media device has a segment 212 of the second media presentation available in a buffer, with the portion s₂ representing content yet to be displayed. In this example, the buffer for the first media presentation at the first media device is more full than the buffer for the second media presentation at the second media device.

Over time, either due to different playback speeds, or perhaps pausing or fast-forwarding activity on one device or the other, the two media presentations may become out of synchronization. FIG. 2B is a timeline view of one example of the media presentations being out of synchronization. At the time t=t₁, the first media device is presenting the first media presentation at playback position v₁. The difference between the elapsed real time and the elapsed program time is δ₁=(v₁−v₀)−(t₁−t₀). The amount of time v₁−v₀ associated with the portion of the first media presentation under consideration may be determined based upon time data associated with the beginning and end of the portion of the first presentation.

When δ₁>0, the media presentation has been playing, on average, faster than real time. When δ₁<0, the media presentation has been playing, on average, slower than real time. In this example, the first media presentation is ahead of the position expected from strict real time playback, and δ₁>0. The second media presentation is behind the position expected from strict real time playback, and δ₂<0.

A synchronization tolerance of β seconds may be set for the presentations. If two media presentation are out of synchronization by at least β seconds, it must be the case that either |δ₁|>β/2 or |δ₂|<β/2, or both. Thus, a local determination at a presentation device of δ, and comparison to β, can be used as one indicator of a potential need for synchronization action. In the example of FIG. 2B, δ₁>β/2. Thus, a determination can be made at the first presentation device that there may have been a loss of synchronization, and that action may be required.

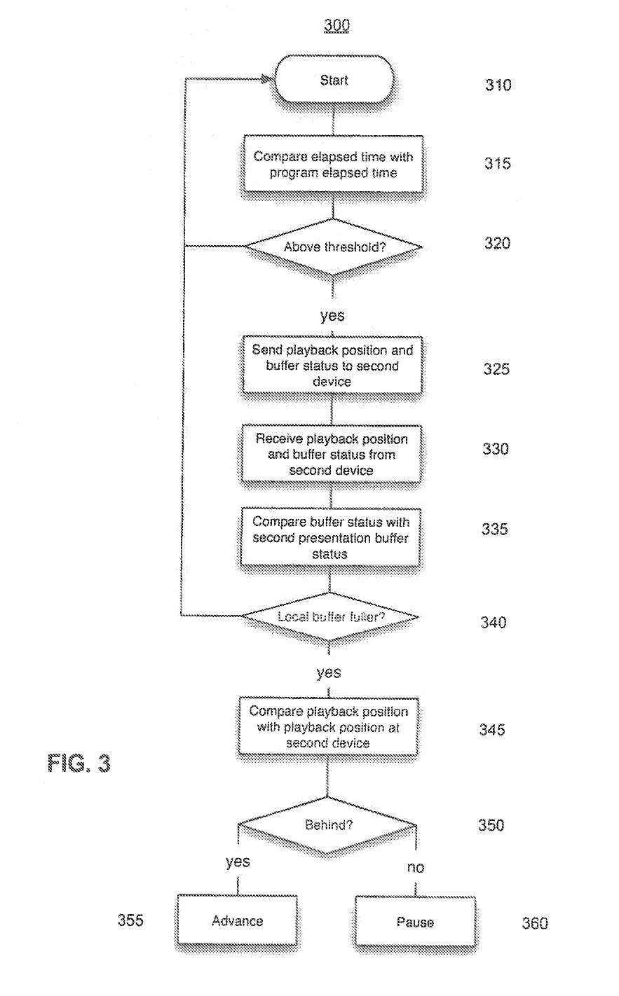

FIG. 3 is a flow chart of a method 300 followed by the devices involved in the synchronization process. In some embodiments, two or more devices may be following the same method.

At step 310, suppose at time t=t₀, the two media presentations are synchronized, and v₁=v₂, as shown in FIG. 2A. The first device compares the time elapsed during presentation of a portion of the first media presentation with an amount of time associated with the portion of the first media presentation at step 315, determining δ₁, for instance.

If the difference between the time elapsed during presentation of the portion of the first media presentation and the amount of time associated with the portion of the first media presentation is found to exceed a threshold, for instance, |δ₁|>β/2, at step 320, the first device sends its playback and buffer status to the second device at step 325. The communication of information including playback position may be performed over a local area network, which may be wired or wireless, or via a combination of networks, potentially including the Internet.

The playback position and buffer status of the second device are received by the first media device at step 330. The indication of the playback position and buffer status of the second media presentation from the second device may be received in response to the first device sending an indication of the playback position and buffer status of the first media presentation to the second device, or as a result of a determination at the second device that its own deviation is also above the threshold.

At step 335, the first device compares the buffer status s₁ of the first media presentation with a buffer status s₂ of the second media presentation at the second device. The determination of which buffer is fuller may be made based upon the amount of time associated with the portion of the media presentation stored in each buffer or upon another measure of the data, such as size. In the presently described embodiment, if the local buffer is determined to be fuller at step 340, that is, s₁>s₂, the first device takes responsibility for synchronizing the presentations.

The playback positions v₁ and v₂ of the two devices are compared at step 345. If the playback position of the first media presentation is found to be behind the playback position of the second media presentation on the second device at step 350, the first device advances playback of the first media presentation to catch up at step 355. That is, if v₁<v₂, the first media presentation is brought up to the playback position of the second media presentation by advancing by v₂−v₁ seconds. The advancing of the media presentation may comprise discarding or skipping presentation of contiguous or discontiguous video frames, or advancing to an appropriate portion of other types of content.

If the playback position of the first media presentation is found to be ahead of the playback position of the second media presentation on the second device at step 350, the first device uses one or more pauses to allow the second media presentation to catch up at step 360. That is, if v₁>v₂, the first device slows playback of the first media presentation by pausing for v₁−v₂ seconds. The pausing of a presentation may comprise multiple pauses of a duration less than the time difference between the playback positions of the first and second media presentations so as to avoid a single longer pause that may be more objectionable to the viewer.

In cases where the local device does not adjust playback to achieve synchronization, the other device, executing the same or a similar algorithm, may.

The method may be performed on a periodic basis, or may also be triggered by indications of network issues or user interaction.

In the embodiment described above, the synchronization task is assigned to the device with the fuller buffer. However, it could be advantageous if, in the case where the device with the less-full buffer is ahead of the other in playback, to have that device pause to reestablish acceptable synchronization. This would have the advantage of increasing the buffer fullness of the device.

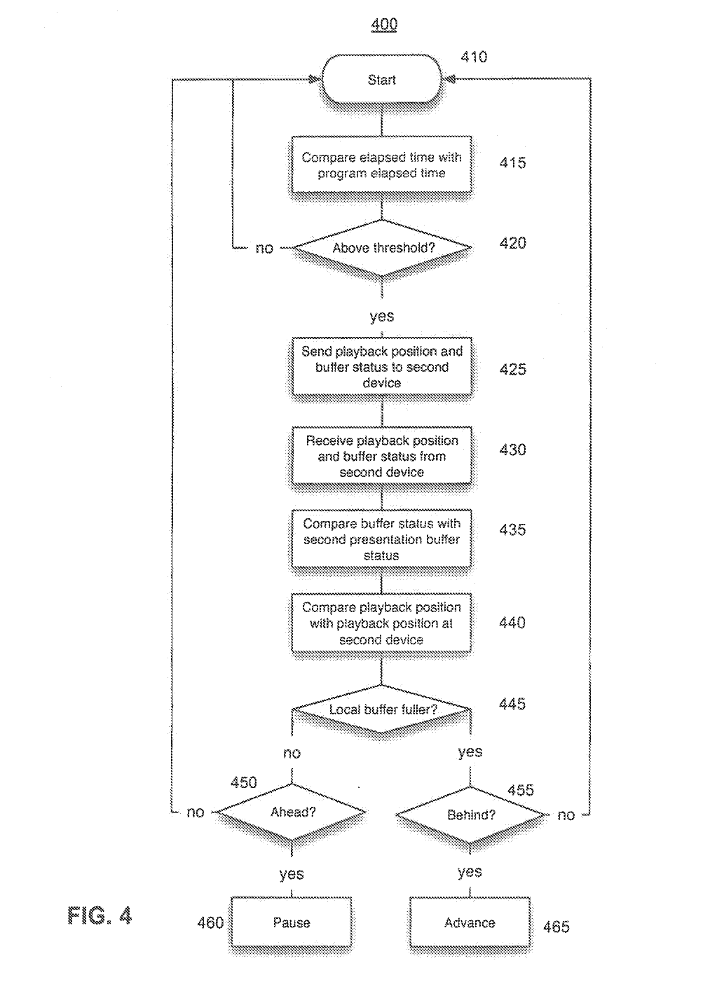

FIG. 4 is a flow chart of such an alternative method 400. At step 410, suppose at time t=t₀, the two media presentations are synchronized, and v₁=v₂, as shown in FIG. 2A. The first device compares the time elapsed during presentation of a portion of the first media presentation with an amount of time associated with the portion of the first media presentation at step 415, determining δ₁, for instance.

If the difference between the time elapsed during presentation of the portion of the first media presentation and the amount of time associated with the portion of the first media presentation is found to exceed a threshold, for instance, |δ₁|>β/2, at step 420, the first device sends its playback and buffer status to the second device at step 425. The communication of information including playback position may be performed over a local area network, which may be wired or wireless, or via a combination of networks, potentially including the Internet.

The playback position and buffer status of the second device are received by the first media device at step 430. The indication of the playback position and buffer status of the second media presentation from the second device may be received in response to the first device sending an indication of the playback position and buffer status of the first media presentation to the second device, or as a result of a determination at the second device that its own deviation is also above threshold.

At step 435, the first device compares the buffer status s₁ of the first media presentation with a buffer status s₂ of the second media presentation at the second device. The determination of which buffer is fuller may be made based upon the amount of time associated with the portion of the media presentation stored in each buffer or upon another measure of the data such as size.

In the presently described embodiment, both the relative buffer fullness and playback position impact whether action will be taken at the device of interest. If the local buffer is determined to be less full at step 445, and the local playback position is determined to be ahead at step 450, the first device uses one or more pauses to allow the second media presentation to catch up at step 460. That is, if s₁<s₂ and v₁>v₂, the first device slows playback of the first media presentation by pausing for v₁−v₂ seconds. The pausing of a presentation may comprise multiple pauses of smaller duration than the time difference between the playback positions of the first and second media presentations so as to avoid a single longer pause that may be more objectionable to the viewer.

If the local buffer is determined to be more full at step 445, and the playback position of the first media presentation is found to be behind the playback position of the second media presentation on the second device at step 455, the first device discards a portion of the first media presentation to catch up at step 465. That is, if s₁>s₂ and v₁<v₂, the first media presentation is brought up to the playback position of the second media presentation by advancing the presentation by v₂−v₁ seconds. The advancing of the media presentation may comprise skipping presentation of contiguous or discontiguous video frames, or advancing to an appropriate portion of other types of content.

In cases where the local device does not adjust playback to achieve synchronization, the other device, executing the same or a similar algorithm, may. The method may be performed on a periodic basis, or may also be triggered by indications of network issues or user interaction.

While the present invention has been described in terms of a specific embodiment, it will be appreciated that modifications may be made which will fall within the scope of the invention. For example, the described methods may be combined with other methods addressing other issues. If a buffer is too full, for instance, a rate control mechanism may be engaged to slow down the transmission rate. The algorithm may also be extended to systems with more than two media devices. For instance, each of the media devices with larger buffer fullness could set their timelines in accordance with the media device with the lowest buffer fullness.

1. A method for coordinating presentation of a first media presentation at a first device and a second media presentation at a second device comprising the steps of:
comparing the time elapsed during presentation of a portion of the first media presentation with an amount of time associated with the portion of the first media presentation;
responsive to a determination that the difference between the time elapsed during presentation of the portion of the first media presentation and the amount of time associated with the portion of the first media presentation exceeds a threshold, performing the steps of:
comparing the buffer status of the first media presentation at the first device with a buffer status of the second media presentation at the second device; and
responsive to a determination that the buffer for the first media presentation on the first device is fuller than the buffer for the second media presentation on the second device, adjusting playback of the first media presentation on the first device.

2. The method of claim 1 further comprising the steps of:
sending an indication of the playback position and buffer status of the first media presentation at the first device to the second device; and
receiving an indication of the playback position and buffer status of the second media presentation from the second device.

3. The method of claim 2 wherein said sending is performed responsive to the determination that the difference between the elapsed time and the time associated with the presented portion of the first media presentation exceeds a threshold.

4. The method of claim 2 wherein the playback position is received via one of a wired or wireless local area network.

5. The method of claim 1 wherein said adjusting playback of said first media presentation on said first device comprises the steps of:
comparing the playback position of the first media presentation at the first device with the playback position of the second media presentation at the second device; and
responsive to a determination that the playback position of the first device is behind the playback position of the second device, advancing playback of the first media presentation based upon the time difference between the playback position of the first media presentation at the first device and the playback position of the second media presentation at the second device, or,
responsive to a determination that the playback position of the first device is ahead of the playback position of the second device, pausing playback for a time selected based upon the difference between the playback position of the first media presentation at the first device and the playback position of the second media presentation at the second device.

6. The method of claim 5 wherein advancing playback of the data stream comprises skipping presentation of video frames.

7. The method of claim 5 wherein said pausing comprises multiple pauses of a duration less than the time difference between the playback position of the first media presentation at the first device and the playback position of the second media presentation at the second device.

8. The method of claim 1 wherein the amount of time associated with the portion of the first media presentation is determined based upon time data associated with the beginning and end of the portion of the first presentation.

9. The method of claim 1 wherein the determination of which buffer is fuller is made based upon the amount of time associated with the portion of the media presentation stored in each buffer.

10. The method of claim 1 wherein said second media presentation comprises information related to the first media presentation.

11. The method of claim 1 wherein at least one of the first media device or the second media device is a handheld computing device.

12. The method of claim 1 wherein at least one of the first media device or the second media device is a television.

13. The method of claim 1 wherein said first media presentation is provided from a first server and said second media presentation is provided from a second server.

14. The method of claim 1 wherein at least one of the first media presentation and the second media presentation comprises video in at least one of MPEG, ASF, WMV, MOV, RM, or RMVB formats.

15. A first media device for presentation of a first media presentation in coordination with a second media presentation on a second device comprising:
a processor for:
comparing the time elapsed during presentation of a portion of the first media presentation with an amount of time associated with the portion of the first media presentation; and
responsive to a determination that the difference between the time elapsed during presentation of the portion of the first media presentation and the amount of time associated with the portion of the first media presentation exceeds a threshold, performing the steps of:
comparing the buffer status of the first media presentation at the first device with a buffer status of the second media presentation at the second device; and
responsive to a determination that the buffer for the first media presentation on the first device is fuller than the buffer for the second media presentation on the second device, adjusting playback of the first media presentation on the first device.

16. The first media device of claim 15 further comprising:
a network interface for:
sending an indication of the playback position and buffer status of the first media presentation at the first device to the second device; and
receiving an indication of the playback position and buffer status of the second media presentation at the second device.

17. The first media device of claim 15 wherein said adjusting playback of said first media presentation on said first device by said processor comprises the steps of:
comparing the playback position of the first media presentation at the first device with the playback position of the second media presentation at the second device; and
responsive to a determination that the playback position of the first device is behind the playback position of the second device, advancing playback of the first media presentation based upon the time difference between the playback position of the first media presentation at the first device and the playback position of the second media presentation at the second device, or,
responsive to a determination that the playback position of the first device is ahead of the playback position of the second device, pausing playback for a time selected based upon the difference between the playback position of the first media presentation at the first device and the playback position of the second media presentation at the second device.

18. The first media device of claim 17 wherein advancing playback of the data stream comprises skipping presentation of video frames.

19. The first media device of claim 17 wherein said pausing is comprises multiple pauses of a duration less than the time difference between the playback position of the first media presentation at the first device and the playback position of the second media presentation at the second device.

20. The first media device of claim 15 wherein the first media device is one of a television or a handheld computing device.

21. A method for coordinating presentation of a first media presentation at a first device and a second media presentation at a second device comprising the steps of:
comparing the time elapsed during presentation of a portion of the first media presentation with an amount of time associated with the portion of the first media presentation;
responsive to a determination that the difference between the time elapsed during presentation of the portion of the first media presentation and the amount of time associated with the portion of the first media presentation exceeds a threshold, performing the steps of:
comparing the buffer status of the first media presentation at the first device with a buffer status of the second media presentation at the second device;
comparing the playback position of the first media presentation at the first device with the playback position of the second media presentation at the second device; and
responsive to determinations that the buffer for the first media presentation on the first device is less full than the buffer for the second media presentation on the second device, and that the playback position of the first device is ahead of the playback position of the second device, pausing playback for a time selected based upon the difference between the playback position of the first media presentation at the first device and the playback position of the second media presentation at the second device.
